(19) United States
(12) Patent Application Publication
(10) Pub. No.: US 2019/0003693 A1
(43) Pub. Date: Jan. 3, 2019

(54) ADAPTIVE CONTROLLED DIMMING

(71) Applicant: First Light Technologies Ltd., Victoria (CA)

(72) Inventors: Brock Johnston, Victoria (CA); Sean Bourquin, Victoria (CA)

(73) Assignee: First Light Technologies Ltd., Victoria (CA)

(21) Appl. No.: 15/650,560

(22) Filed: Jul. 14, 2017

(30) Foreign Application Priority Data
Jun. 30, 2017 (CA) 2972123

(51) Int. Cl. F21V 23/04; H05B 37/02

(52) U.S. Cl. CPC F21V 23/0471; H05B 37/0245; H05B 37/0227

(57) ABSTRACT

An adaptive system for controlling the dimming of a light monitors area occupancy as detected by a sensor over successive similar time intervals. The usage is averaged and used to predictively control the brightness of the illumination of the area at corresponding time interval without relying on the sensor to trigger the illumination on a piecemeal basis. The degree of illumination adapts to the statistical average of the number of users in the area over time in the time intervals of interest.

### FIELD OF THE INVENTION

This invention relates to dimmable lights. In particular, this invention relates to a system and method for adaptively controlling dimmable lights.

### BACKGROUND OF THE INVENTION

Motion sensors are used in lighting to save energy and reduce light pollution. They turn on the light only when someone is present. Presently, both indoor and outdoor area lighting is available with motion sensors to allow the light to turn on or increase brightness upon the detection of a user. Motion sensors are included in many light switches available for indoor lighting. This solution works well for indoor lighting because the motion sensors often detect the person entering the room sooner that they could otherwise reach the light switch themselves. The switch both comes on earlier and adds the convenience of not needing to manually use a switch.

In outdoor applications, such as street lighting, motion sensors often fail to provide adequate lighting because they often do not activate until the person is almost directly under the light and the area nearby may be completely dark. This is especially true for fast moving users, such as cyclists or cars.

In addition, lighting products are available with automatic dimming profiles that use pre-determined schedules to dim lights in the middle of the night, when usage is less likely. Lights with automatic dimming generally provide several different dimming profiles to allow users to choose a profile that matches the needs of that location. Common dimming profiles come on at full brightness at dusk for several hours, dim through the night and increase back to full brightness one or two hours before dawn. These profiles are usually chosen based on a best-guess of when users are likely to be present, as it is difficult to know when people are using a path or road. The lights may actually be on at a bright level when not needed and at a dim level when they should be bright.

It is therefore an object of the invention to provide an improved lighting system and method that provides an appropriate level of lighting prior to a user coming within the detection range of a motion sensor.

It is a further object of the invention to provide a lighting system and method that is adaptable to the likelihood of users being present in its vicinity at varying times.

These and other objects of the invention will be better understood by reference to the detailed description of the preferred embodiment which follows. Note that the objects referred to above are statements of what motivated the invention rather than promises. Not all of the objects are necessarily met by all embodiments of the invention described below or by the invention defined by each of the claims.

### SUMMARY OF THE INVENTION

The present invention provides an area luminaire control system with the ability to adapt and create a dimming profile automatically based on statistical data collected by an occupancy sensor. The occupancy sensor may be a passive infrared (PIR) motion sensor, ultrasonic proximity sensor or any other suitable sensor for detecting the presence of a user in an area. A processor and memory are in communication with the sensor. The sensor detects the actual usage in the area of interest and the processor tracks the usage, calculates and stores the usage data for specific recurring time intervals. A suitable metric is calculated for each recurring interval to provide a control parameter for responding to changing and evolving usage of the area over time.

For example, the processor may calculate and store an average of a metric for the occupancy in the vicinity of a luminaire for specific time intervals for each day of the week (where Thursday night from 22:00-22:30 may have a different average than Friday night from 22:00-22:30 for instance), calculate and store the average only for a specific time interval treating every day the same, or store different averages for different days, for example one for weekdays and another for weekends.

The control system of the invention is usable in communication with a luminaire. It may be supplied separately or be integrated with an occupancy sensor, and/or packaged as a system including the luminaire.

In one aspect, the invention therefore comprises a method of controlling the light output of a dimmable light comprising recording the output of an occupancy sensor over a plurality of occurrences of a time interval of interest in the vicinity of the light, calculating a metric that is a function of the output over the plurality of is occurrences and controlling the light output during a subsequent occurrence of the time interval of interest based on the metric.

The method may further comprise recording the output of the occupancy sensor over the subsequent occurrence and recalculating the metric taking into account the output of the occupancy sensor over that subsequent occurrence. Controlling the light output may involve dimming it according to one more predetermined thresholds for the metric.

The metric may be an average percentage of the time in the interval of interest during which occupancy was previously detected, or an average number of users during the time interval of interest previously detected in that vicinity, among other possible metrics.

The method may additionally include the step of detecting the onset of dusk and dawn, where the time interval of interest is between dusk and dawn or is a specific time interval that falls between dusk and dawn.

The method can further include increasing the brightness of the light in response to a user being detected by the occupancy sensor.

In another aspect, the invention is a light output control system comprising a dimmable light, an occupancy sensor, memory for recording occupancy sensor outputs, a processor connected to the dimmable light, the occupancy sensor and the memory. The processor has an output for selectively controlling the dimming of the light and is configured to calculate an average associated with a plurality of occurrences of a time interval of interest, and to selectively dim the light in a subsequent occurrence of the time interval of interest as a function of the average.

The processor may be further configured to recalculate the average taking into is account the occupancy sensor outputs during the subsequent occurrence.

A light sensor may be connected to the processor, including wirelessly, as may the dimmable light, the occupancy sensor and the memory.

The processor may be further configured to increase the brightness of the light in response to a user being detected by the occupancy sensor.

In a further embodiment, the invention is a light output control system for a dimmable light, comprising a processor having an input for an occupancy sensor and an output for a dimmable light, memory for recording occupancy sensor outputs, the memory being connected to the processor, wherein the processor output selectively controls the dimming of the dimmable light, the processor is configured to calculate an average associated with a plurality of occurrences of a time interval of interest and the processor is configured to selectively dim the dimmable light in a subsequent occurrence of the time interval of interest as a function of the average.

The occupancy sensor may be connected to the processor.

The processor may be further configured to recalculate the average taking into account a record of the occupancy sensor outputs during the subsequent occurrence. It may have an input for a light sensor or it may comprise a light sensor connected to the processor.

Communication of the processor with the other components may be wireless.

In a further aspect, the invention is a method of controlling the light output of a dimmable light comprising determining an average presence of users of a given repeating time interval of interest over a plurality of past occurrences of the time interval of interest in a vicinity of the light and controlling the light output during a new occurrence of the time interval of interest based on the average.

The step of determining an average presence of users of a given repeating time interval of interest over a plurality of past occurrences of the time interval of interest in a vicinity of the light may be done through accessing usage data from an external database containing historical averages of the presence of users.

That average may be a 30-day moving average, an average of a time interval for every day of the week, an average of a time interval for a particular day of the week, an average of a time interval for weekdays or an average of a time interval for weekends, among other averages.

The occupancy detector and the metric may be based on people or vehicles, among other things.

The foregoing may cover only some of the aspects of the invention. Other aspects of the invention may be appreciated by reference to the following description of at least one preferred mode for carrying out the invention in terms of one or more examples. The following mode(s) for carrying out the invention is not a definition of the invention itself, but is only an example that embodies the inventive features of the invention.

### BRIEF DESCRIPTION OF THE DRAWINGS

At least one mode for carrying out the invention in terms of one or more examples will be described by reference to the drawings thereof in which:

FIG. 1 is a diagram of the control system of one embodiment of the invention;

FIG. 2 is a flowchart of the main routine according to the preferred embodiment of the invention;

FIG. 3 is a chart showing an example average percentage usage and light intensity against time;

FIG. 4 is a flowchart showing the routine of the smart profile;

FIG. 5 is a diagram of the control system of a second embodiment of the invention; and

FIG. 6 is a diagram of the control system of a third embodiment of the invention.

### DETAILED DESCRIPTION OF AT LEAST ONE MODE FOR CARRYING OUT THE INVENTION IN TERMS OF EXAMPLE(S)

A preferred and alternate embodiments of the light output control systems will be discussed below. However, the example systems control the brightness in generally the same manner, namely based on parameters derived from statistical occupancy data for the area to be illuminated. A processor receives input from an occupancy sensor and records such output in memory. Occupancy data is collected over a plurality of recurring instances of a time interval of interest. For instance, the interval of interest may be from 19:00 to 21:00 every day, or every Friday, and so forth.

The system calculates a metric that is a function of the occupancy sensor output over the plurality of occurrences of the interval of interest. The metric used may vary depending on the objectives. It may be derived from the average percentage of the interval of interest during which the occupancy sensor or sensors previously detected users in the area of interest. Alternatively, the metric may be derived from the number of users previously detected in the area of interest, assuming that means are provided to assess such number of users. Other metrics derived from the statistical occupancy data are also possible.

The adaptive light output control system described herein may be used in a variety of environments, including parking lots, roadways, and footpaths.

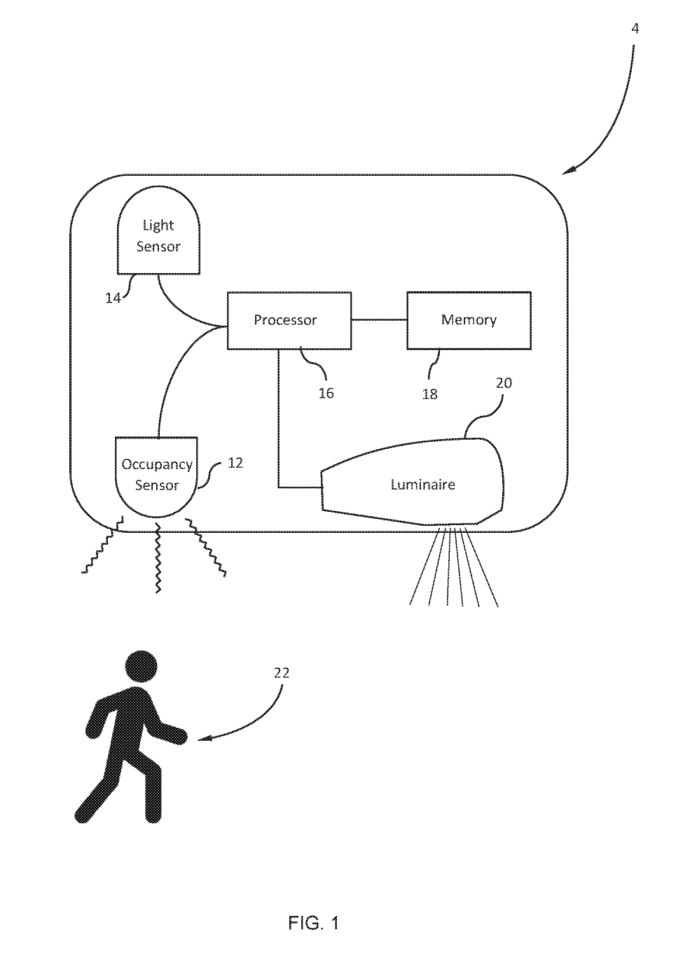

FIG. 1 shows an integrated luminaire and adaptive control system 10 according to a preferred embodiment of the invention. The system 10 includes an occupancy sensor 12, an ambient light sensor 14, a processor 16, memory 18, and a luminaire 20. Luminaire 20 is preferably a dimmable LED light, using LED drivers with 0-10V dimming inputs, and the occupancy sensor 12 is a passive infrared motion sensor that generates a 3.3V signal while motion is detected, for instance by a person 22 walking by.

The processor 16 monitors the occupancy sensor 12 output and records in memory 18 the outputs for the predetermined time intervals of interest. For example, for each daily time interval between 17:00 and 7:00, the processor 16 may record the portions (percentage) of those intervals in which motion was detected. According to that example, if the output of the occupancy sensor 12 was at 3.3V for five of the 30 minutes, the processor 16 would calculate and record 0.166 or 16.6% for that 30 minute interval.

A desirable metric to be used for control purposes may be derived from an average occupancy for the time intervals of interest. As used herein and in the claims, the term “average” includes various kinds of averages including mean, median and mode. A running average for the time intervals of interest may be maintained such that it is recalculated as more data is collected in subsequent occurrences of the interval in question. The control system may therefore maintain a running average (e.g. a 30 day running average, a 4 month running is average, etc.) to allow the system to adjust for seasonal differences.

Table 1 below is a data table providing example data of the averages that are stored. These are averages of the proportion of time that a monitored area is occupied in the given time interval.

TABLE 1

| | Mon- | Tues- | Wednes- | Thurs- | Fri- | Satur- | Sun- |
|---|---|---|---|---|---|---|---|
| Time | day | day | day | day | day | day | day |
| 17:00 | 0.48 | 0.75 | 0.6 | 0.75 | 0.75 | 0.75 | 0.75 |
| 17:30 | 0.544 | 0.85 | 0.68 | 0.85 | 0.85 | 0.85 | 0.85 |
| 18:00 | 0.512 | 0.8 | 0.64 | 0.8 | 0.8 | 0.8 | 0.8 |
| 18:30 | 0.576 | 0.9 | 0.72 | 0.9 | 0.9 | 0.9 | 0.9 |
| 19:00 | 0.5312 | 0.83 | 0.664 | 0.83 | 0.83 | 0.83 | 0.83 |
| 19:30 | 0.4608 | 0.72 | 0.576 | 0.72 | 0.72 | 0.72 | 0.72 |
| 20:00 | 0.4992 | 0.78 | 0.624 | 0.78 | 0.78 | 0.78 | 0.78 |
| 20:30 | 0.416 | 0.65 | 0.52 | 0.65 | 0.65 | 0.65 | 0.65 |
| 21:00 | 0.3968 | 0.62 | 0.496 | 0.62 | 0.62 | 0.62 | 0.62 |
| 21:30 | 0.352 | 0.55 | 0.44 | 0.55 | 0.55 | 0.55 | 0.55 |
| 22:00 | 0.2048 | 0.32 | 0.256 | 0.32 | 0.32 | 0.32 | 0.32 |
| 22:30 | 0.1344 | 0.21 | 0.168 | 0.21 | 0.21 | 0.21 | 0.21 |
| 23:00 | 0.0512 | 0.08 | 0.064 | 0.08 | 0.08 | 0.08 | 0.08 |
| 23:30 | 0.0192 | 0.03 | 0.024 | 0.03 | 0.03 | 0.03 | 0.03 |
| 0:00 | 0 | 0 | 0 | 0 | 0 | 0 | 0 |
| 0:30 | 0 | 0 | 0 | 0 | 0 | 0 | 0 |
| 1:00 | 0 | 0 | 0 | 0 | 0 | 0 | 0 |
| 1:30 | 0 | | 0 | | 0.05 | 0.05 | |
| 2:00 | 0 | | 0 | | 0.15 | 0.15 | |
| 2:30 | 0 | | 0 | | 0.02 | 0.02 | |
| 3:00 | 0 | 0 | 0 | 0 | 0 | 0 | 0 |
| 3:30 | 0 | 0 | 0 | 0 | 0 | 0 | 0 |
| 4:00 | 0 | 0 | 0 | 0 | 0 | 0 | 0 |
| 4:30 | 0 | 0 | 0 | 0 | 0 | 0 | 0 |
| 5:00 | 0.0192 | 0.03 | 0.024 | 0.03 | 0.03 | 0.03 | 0.03 |
| 5:30 | 0.1024 | 0.16 | 0.128 | 0.16 | 0.16 | 0.16 | 0.16 |
| 6:00 | 0.224 | 0.35 | 0.28 | 0.35 | 0.35 | 0.35 | 0.35 |
| 6:30 | 0.512 | 0.8 | 0.64 | 0.8 | 0.8 | 0.8 | 0.8 |
| 7:00 | 0.48 | 0.75 | 0.6 | 0.75 | 0.75 | 0.75 | 0.75 |

In the above example, the processor 16 only recorded data and calculated averages for time intervals that are likely to require lighting, such as night time. Table 1 represents data collected from dusk at 17:00 to dawn at 7:00, dusk and dawn being at those times at the location and season in question, with the onset of dusk and dawn and consequent activation of the system being optionally detected and controlled by the ambient light sensor 14. There may also be no restriction as to the time of day in which the system collects data. Rather than operating from 17:00 to 7:00, the system may collect data throughout the day, recording averages for predetermined time intervals during the day, for example in 30 minute blocks. Such an approach would provide a more fully adaptive system, at the expense of processing resources and possible lighting during periods that might otherwise be optional.

At an appropriate time, which may be at a predetermined time before lighting may potentially be needed, the processor 16 looks up pre-calculated running averages, or analyzes the data to calculate the running averages for each post-dusk time interval for that day. For example, if the time interval is 30 minutes and dusk on the day in question is at 19:00, the first post-dusk time interval is from 19:00-19:30, the second one is from 19:30-20:00, and the third one is from is 20:00-20:30. The running average for all previous occurrences of the first interval from 19:00-19:30 is determined. Alternatively, the running average for a pre-programmed set or subset of previous occurrences (for instance, only the last 4 weeks) of the 19:00-19:30 interval may be determined. The subset may be a single previous occurrence of the time interval such that the dimming profile for the same interval on the current day is based on the actual occupancy profile of the previous day for that same interval.

In a further alternative, the processor 16 may look up the data for each post-dusk interval of the same day of the week during the previous week. This might be done because the data collected for the same weekday in the previous week may be a better predictor than the data collected for the last day.

In yet a further alternative, the processor 16 may look up the data for each post-dusk interval of the same date in the previous year. Using Monday, Jan. 1, 2019 as an example, the processor could look up the data from Sunday, Jan. 1, 2018. This may be done since it is known that in a certain entertainment district, the number of people that walk past a certain light during a certain time on New Years' Day is similar from year to year.

The metric used to control the dimming or brightening of the luminaire is measure of the statistical presence of users in the monitored area, such as the percentage of time within a given 30-minute interval that motion is detected or an average of such percentages over recurring instances of the time period/interval of interest (e.g. 17:00-17:30 each day). A configurable threshold of that metric may then be used to determine whether to operate the luminaire at full brightness or at a dimmed level for a subsequent occurrence of that interval.

In a 30-minute interval, a metric may be the average percentage of time of that interval during which motion is detected and a threshold may be a running average of over 50%. Thus when the running average of occupancy for a given is interval is over 50%, the processor will control the luminaire to operate at full brightness during the next occurrence of the time interval. During that next occurrence, data from the occupancy sensor will again be collected and may result in a different luminaire behaviour in the next occurrence of the interval.

The control metric may be different. For example, rather than being based on a percentage of time during which the area is occupied, it may be derived instead from the number of users in the area rather than how long they are in the area. A configurable threshold based on the metric may be 0 users, 50 users or 100 users.

An operator such as a municipality may decide that if there is any chance of usage, the lights should be on at full brightness. In such case, the threshold may be set at zero (in terms of occupancy percentage or number of occupants) such that any sensor output above zero (for a given running average evaluation period) meets the threshold. In this example, the processor 16 uses the predetermined threshold of zero to determine whether the luminaire will be on at full brightness.

Expanding on the zero-threshold example, if the processor is configured to record and calculate the metric using all previous occurrences of a specific time interval, then if any one of the previous occurrences of the specific interval of interest has a non-zero value, the metric will be greater than zero if a mean of the data is used to calculated the metric. However, if a mode or median is used, then the metric may still be zero. Furthermore, if the metric is calculated using a rolling time-period (for instance, only using data from the most recent 7 prior occurrences), then a non-zero measurement beyond the rolling time-period will not affect the metric.

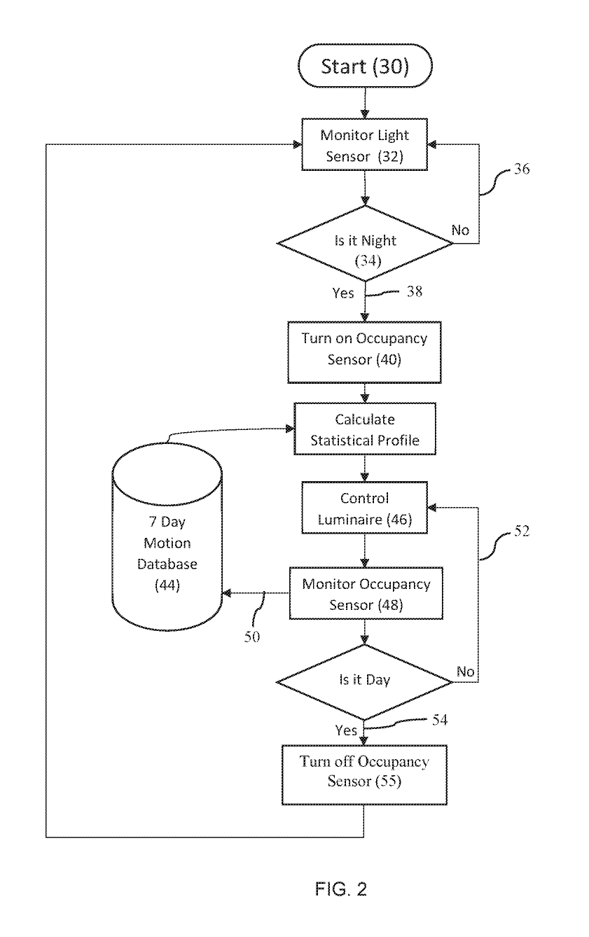

FIG. 2 is a flowchart of the main control methodology according to a preferred embodiment of the invention, in which an ambient light sensor triggers the operation of the data collection and luminaire control. The routine begins (30) with the processor 16 monitoring (32) the output of the ambient light sensor 14, which detects whether it is night. If it is night (38), the processor 16 activates (40) the occupancy sensor 12. The processor 16 calculates (42) a statistical profile (for example an average) using a 7-day occupancy database 44 stored in memory 18. It will be appreciated that the evaluation period of 7 days may vary. For instance, a monthly 30-day motion database or a yearly 365-day motion database could be used. The processor controls (46) the luminaire and monitors (48) the occupancy sensor 12 to collect data for the coming interval. It is contemplated that the loop from (42) to (46), (48), (50), 44) to (42) will run only once at the beginning of each interval of interest.

New usage data from the occupancy sensor 12 is used to recalculate (50) the running average for each interval on the 7-day motion database 44 stored in memory 18. The recalculated averages are then used to determine the brightness for subsequent occurrences of the intervals of interest.

As noted above, the data may for example record the number of users or a portion of the interval when users are detected. For the detection of the number of users, various sensors such as Texas Instruments' Thermopile-Based Occupancy Detector for People Counting Applications and various video systems such as Traffic Vision's software for Intelligent Transportation Systems may be used.

In an example, the processor monitors the sensor for the interval from 21:00 to 21:30 on Monday night. The occupancy sensor detects the presence of users for 15 minutes out of the 30 minute interval. The processor may calculate the percentage usage for the interval, in this case 50%, and recalculate the stored running average for that recurring interval over successive days or weeks.

The processor may be configured to use the stored average to determine how is bright to operate the luminaire for each interval. The processor might use a predetermined threshold of average usage to decide between full brightness and a dimmed level of brightness. For example, if the average usage for an interval is less than 10% the processor would use the dimmed level while if the usage is 10% or greater, the processor would use the full brightness. It is also possible to use more than one threshold, providing three or more brightness levels.

A further embodiment could use the average usage as the dimming level. For example, if the average usage was 27%, the light level would be 27% of full brightness.

Day and night may be detected by ambient light sensor 14. While is it not day (52), the processor controls (46) the luminaire and monitors (48) occupancy or motion. Once it is day (54), the processor 16 turns off (55) the occupancy sensor 12 and monitors (32) the ambient light sensor again.

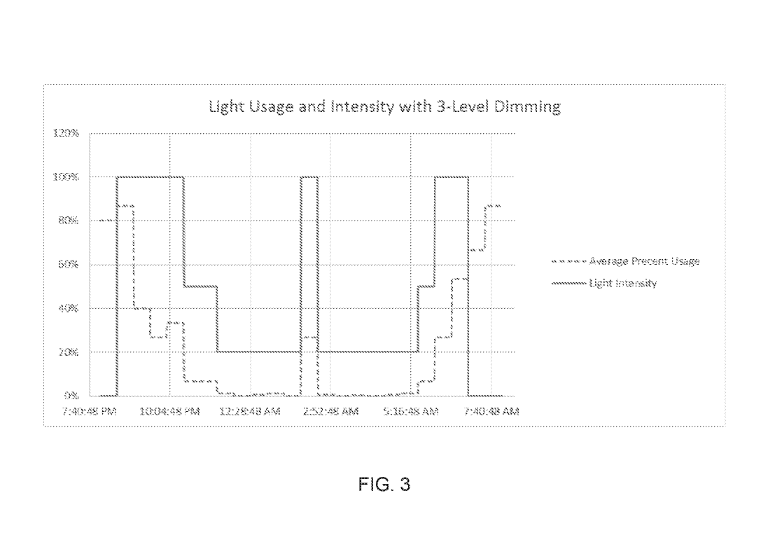

FIG. 3 shows an example chart of the percent usage and the corresponding light output with a three-level dimming profile for a Friday night in an entertainment district. According to the example the light becomes brighter at 2:00 a.m. in response to a history of motion detection from people leaving night clubs at 2:00 a.m., after a Friday night out. In this example, the light has three levels of brightness (20% brightness, 50% brightness, and 100% brightness). If the average usage for a time interval is below 5%, the light is set to operate on the lowest of the three available levels, in this case 20% brightness. If the average usage for a time interval is equal to or above 5% but below 30%, the light operates on the middle setting, in this case 50% brightness. If the average usage for a time intervalis equal to or above 30%, the light operates on the highest setting, in this case 100% brightness.

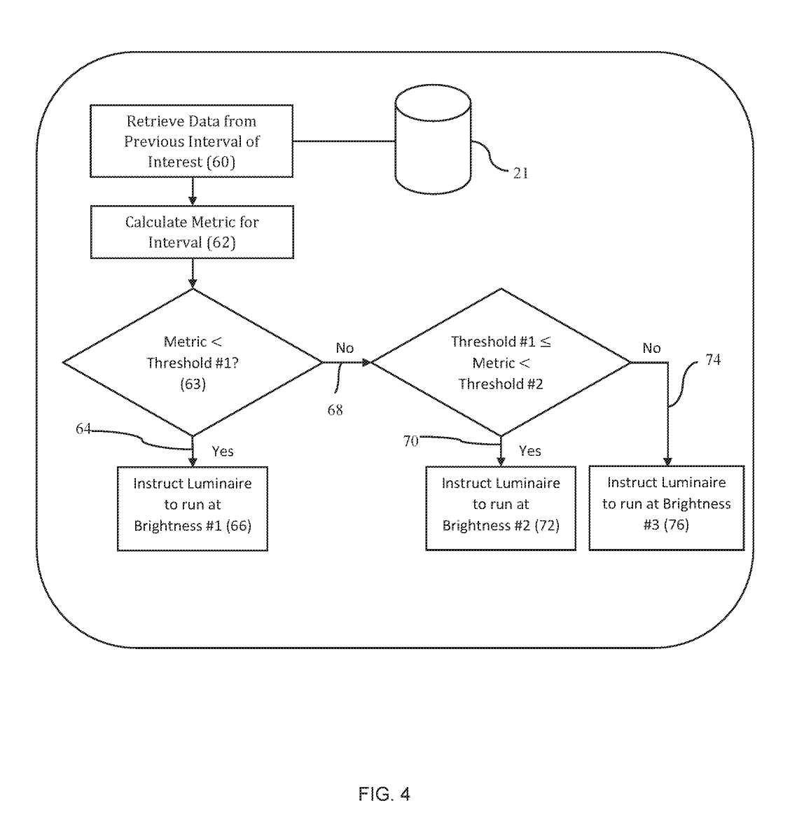

is FIG. 4 shows an example process of calculating a metric and applying a threshold to control the luminaire of steps (42) and (46) of FIG. 2. The processor accesses the database 21 and retrieves previous occupancy data (60) for the interval of interest. The processor then calculates a metric for the interval based on that data (62). The calculation for the metric could be the same for any given interval, or could vary dependent on the interval of interest, the extent of the occupancy data, or other factors.

Referring to FIG. 3 and FIG. 4, the processor compares (63) the calculated metric against pre-defined thresholds to determine the control instructions to be sent to the luminaire. There are two thresholds in this example, resulting in a total of three possible real number ranges corresponding with three different brightness levels for the luminaire. The brightness levels numbered 1 through 3 may respectively represent 20% brightness, 50% brightness and 100% brightness of the luminaire as was used in in the example shown in FIG. 3.

If the calculated metric is less than Threshold #1 (64), then the processor instructs the luminaire to run at Brightness #1 (66). If the calculated metric is not less than Threshold #1 (68), then the processor subsequently determines whether the calculated metric is less than Threshold #2, and if so (70) instructs the luminaire to run at Brightness #2 (72). If the calculated metric is greater than or equal to Threshold #2 (74), then the processor alternatively instructs the luminaire to run at Brightness #3 (76).

Fewer or more thresholds, and fewer or more brightness levels, could be used. Brightness levels could include a brightness level equivalent to no light output for the luminaire, or 0% brightness. Additionally, more than one threshold range may be associated with a single brightness level. Furthermore, the control of the luminaire may be based not on pre-defined thresholds or real number ranges as is shown in the above example, but rather on a linear or non-linear formula that uses the metric as a variable, and has an output that represents the exact brightness level instruction for the luminaire.

The system of the invention may be bundled with a light emitting luminaire and a sensor in a single package, it may be separate but in communication therewith for providing control of the luminaire or it may be a component adapted to be integrated with a sensor or a luminaire. The system may be modular with one or more electrical or wireless connections for sensor(s) and/or luminaire(s).

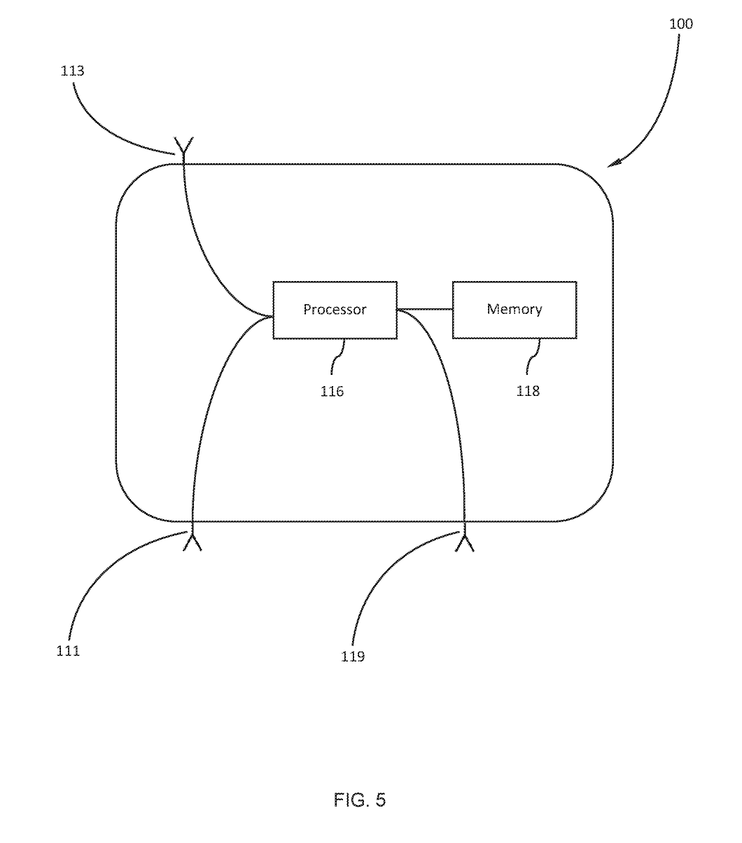

Referring to FIG. 5, in one embodiment the adaptive control system 100 is presented as a component or module that includes a connection 111 for an occupancy sensor, a connection 113 for a light sensor, a processor 116, memory 118, and a connection 119 for a luminaire. Connection 111, connection 113, memory 118, and connection 119 are all in communication with the processor 116.

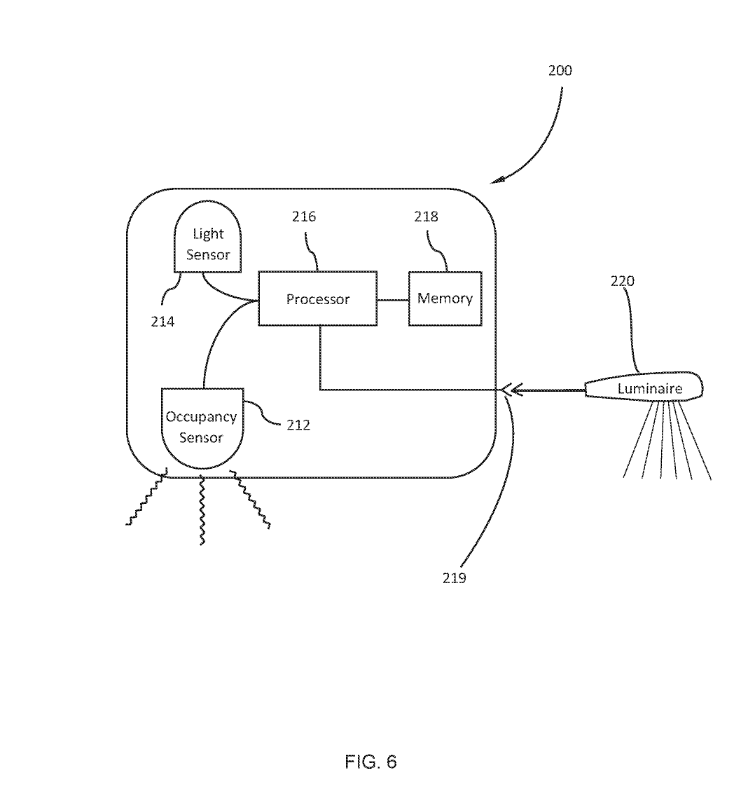

FIG. 6 shows a further embodiment in which the adaptive control system 200 includes an occupancy sensor 212, a light sensor 214, a processor 216, memory 218, and a connection 219 for a luminaire 220. Occupancy sensor 212, light sensor 214, memory 218, and connection 219 are all in communication with processor 216.

System 100 (and system 200 when connected to an occupancy sensor) monitor and store usage data that is used to control the brightness of a dimmable luminaire connectable to system 100 (and system 200 ).

The adaptive control system may also run without a light sensor. Instead of detecting whether it is day or night, the system may be configured based on the daily sunrise and sunset times in the geographical area it is employed. Alternatively, the adaptive control system may be configured to always turn on is the occupancy sensor at a time around dusk (for example, 19:00) and turn off the occupancy sensor at another time around dawn (for example, 07:00).

It will be appreciated that wired or wireless connections (and wireless communication) between the various components of the adaptive control systems 10, 100, and 200 is possible. As one non-limiting example, and referring to FIG. 5, an occupancy sensor could be wirelessly connected to the processor 116. In this example, the occupancy sensor could be physically separated meters away from the processor and adaptive control system 100. For instance, the occupancy sensor could be located at street level while the light sensor, processor 116, and luminaire could be located at the top of a light post. Using wireless communication, a long wire between the occupancy sensor and processor would not be required.

In alternate embodiments of the invention, the adaptive control system may be configured to access usage data from an external database rather than from its internal memory. In such case, the external database preferably has usage data tied to the approximate geographical location of the adaptive control system and the system preferably sends new usage data to the external database to update usage averages on the external database.

Finally it will be appreciated that in addition to the adaptive dimming discussed above, the adaptive control system may also increase the brightness of the luminaire if it is dim or turn on the luminaire if it is off in response to the occupancy sensor detecting the presence of a user.

In other embodiments, it is contemplated that a machine learning system may be used rather than the calculation of predefined metrics and thresholds in order to determine adaptive control parameters based on the statistical data collected during recurring intervals of interest.

is An enhancement to the invention contemplates the feed of event scheduling data from a communication network to allow the interpretation of event schedules (e.g. a hockey or basketball game) and their correlation to time intervals of ienterst. The occurrence of such events during an interval of interest may be relied on to override the statistical data in operating a control profile for the luminaire.

In the foregoing description, exemplary modes for carrying out the invention in terms of examples have been described. However, the scope of the claims should not be limited by those examples, but should be given the broadest interpretation consistent with the description as a whole. The specification and drawings are, accordingly, to be regarded in an illustrative rather than a restrictive sense.

1. A method of controlling a light output of a dimmable light comprising:
recording an output of an occupancy sensor over a plurality of occurrences of a time interval of interest in the vicinity of said light;
calculating a metric that is a function of said output over said plurality of occurrences; and
controlling said light output during a subsequent occurrence of said time interval of interest based on said metric.

2. The method of claim 1 further comprising:
recording the output of said occupancy sensor over said subsequent occurrence; and
recalculating said metric taking into account the output of said occupancy sensor over said subsequent occurrence.

3. The method of claim 1 wherein said step of controlling the light output comprises dimming said light output according to whether a predetermined threshold for said metric is exceeded.

4. The method of claim 1 wherein said step of controlling the light output comprises dimming said light output according to a plurality of predetermined thresholds.

5. The method of claim 1 wherein said metric is an average percentage of said time interval of interest during which occupancy was previously detected.

6. The method of claim 1 wherein said metric is an average number of users during said time interval of interest previously detected in said vicinity.

7. The method of claim 1 further comprising the step of detecting the onset of dusk and dawn, and said time interval of interest is between dusk and dawn.

8. The method of claim 1 wherein said time interval of interest is a predetermined time interval that falls between dusk and dawn.

9. The method of claim 1 further comprising the step of increasing the brightness of said light in response to a user being detected by said occupancy sensor.

10. A light output control system comprising:
a dimmable light;
an occupancy sensor in the vicinity of said light;
memory for recording occupancy sensor outputs;
a processor connected to said dimmable light, said occupancy sensor, and said memory;
wherein said processor has an output for selectively controlling the dimming of said light;
wherein said processor is configured to calculate an average associated with a plurality of occurrences of a time interval of interest; and
wherein said processor is configured to selectively dim said light in a subsequent occurrence of said time interval of interest as a function of said average.

11. The system of claim 10 wherein said processor is further configured to recalculate said average taking into account the occupancy sensor outputs during said subsequent occurrence.

12. The system of claim 10 wherein said system is further configured to increase the brightness of said light in response to a user being detected by said occupancy sensor.

13. A light output control system for a dimmable light, said system comprising:
a processor having an input for an occupancy sensor and an output for a-the dimmable light;
a memory for recording occupancy sensor outputs, said memory being connected to said processor;
wherein said processor output selectively controls the dimming of said dimmable light;
wherein said processor is configured to calculate an average associated with a plurality of occurrences of a time interval of interest;
and wherein said processor is configured to selectively dim said dimmable light in a subsequent occurrence of said time interval of interest as a function of said average.

14. The system of claim 13 further comprising an occupancy sensor connected to said processor.

15. The system of claim 13 wherein said processor is further configured to recalculate said average taking into account a record of said occupancy sensor outputs during said subsequent occurrence.

16. The system of claim 13 wherein said processor has an input for a light sensor.

17. The system of claim 13 further comprising a light sensor connected to said processor.

18. The system of claim 13 wherein said processor is in wireless communication with one or more of said dimmable light, said occupancy sensor, and said memory.

19. A method of controlling the a light output of a dimmable light comprising:
determining an average presence of users of a given repeating time interval of interest over a plurality of past occurrences of said time interval of interest in a vicinity of said light; and
controlling said light output during a new occurrence of said time interval of interest based on said average.

20. The method of claim 19 wherein said step of determining an average presence of users of a given repeating time interval of interest over a plurality of past occurrences of said time interval of interest in a vicinity of said light is done through accessing usage data from an external database containing historical averages of the presence of users.
